(19) United States
(12) Patent Application Publication
(10) Pub. No.: US 2024/0284819 A1
(43) Pub. Date: Aug. 29, 2024

(54) CROP INPUT APPLICATION APPARATUS, SYSTEMS AND METHODS

(71) Applicant: MA Industries, LLC, Morton, IL (US)

(72) Inventors: Greggory Sauder, Morton, IL (US); Timothy Sauder, Morton, IL (US); Justin Koch, Morton, IL (US); Nowell Moore, Morton, IL (US); Reid Aberle, Morton, IL (US); Tyler Nafzinger, Mortin, IL (US); Conner Hesterberg, Morton, IL (US); Jonathan Welte, Morton, IL (US); Kyle Waremburg, Morton, IL (US); Steven Nuest, Morton, IL (US)

(21) Appl. No.: 18/652,475

(22) Filed: May 1, 2024

Related U.S. Application Data
(63) Continuation of application No. PCT/US2021/072169, filed on Nov. 1, 2021.
(63) Continuation of application No. PCT/US21/72159, filed on Nov. 1, 2021.
(60) Provisional application No. 63/260,444, filed on Aug. 19, 2021.
(60) Provisional application No. 63/149,644, filed on Feb. 15, 2021.
(60) Provisional application No. 63/138,222, filed on Jan. 15, 2021.
(60) Provisional application No. 63/107,608, filed on Oct. 30, 2020.

(51) Int. Cl. A01C 7/06; A01B 69/04; A01C 7/08; A01C 15/00; A01C 21/00; A01C 23/04; A01G 25/09; A01H 1/02; H02G 11/02

(52) U.S. Cl. CPC A01C 7/06; A01B 69/008; A01C 7/081; A01C 15/005; A01C 21/007; A01C 23/042; A01G 25/09; A01H 1/027; H02G 11/02

(57) ABSTRACT

Concepts presented herein relate to use of one or more vehicles in planting and growing crops. In some embodiments, the vehicles can operate autonomously or semi-autonomously. During use, the vehicles can apply seeds for planting and further apply agricultural inputs to a crop after planting.

### BACKGROUND

Applicators such as irrigation systems, sprayers, side-dress bars, etc., are used to apply one or more crop inputs; some embodiments are used to apply one or more crop inputs to a standing crop.

### BRIEF DESCRIPTION OF THE DRAWINGS

FIG. 1A is a schematic view of a vehicle in a field.

FIG. 1B is a schematic view of a field having paths therein.

FIG. 2 is a schematic view of a vehicle having a planter.

FIG. 3 is a close-up schematic view of the planter of FIG. 2.

FIG. 4 is a schematic view of a seed positioned in a cartridge.

FIG. 5 is a schematic front view of a seed.

FIG. 6 is a schematic side view of the seed of FIG. 5.

FIG. 7 is a schematic view of a seed positioned within a furrow.

FIG. 8 is a schematic side view of a planter connected with a vehicle.

FIG. 9 is a schematic view of seeds disposed within a tape.

FIG. 10 is a schematic rear view of a boom and a drop extending from the boom.

FIG. 11 is a close-up schematic view of the drop in FIG. 10.

FIG. 12 is a schematic view of a system for supplying agricultural input to a vehicle.

FIG. 13 is a schematic view of a system for supplying agricultural input that includes dry particulate.

FIG. 14 is a schematic view of a vehicle that processes dry particulate.

FIG. 15 is a schematic view of a vehicle with a concentrate injection system.

FIG. 16 is a schematic view of a boom and a plurality of drops.

FIG. 17 is a schematic view of a boom and a drop.

FIG. 18 is a schematic view of a vehicle.

FIG. 19 is a schematic view of the vehicle and a dispensing unit.

FIG. 20 is a schematic view of a field.

FIG. 21 is a schematic view of a vehicle and a fill station.

FIG. 22 is a schematic view of a holding area providing manure to a conduit.

FIG. 23 is a schematic view of a holding area and components providing input to a conduit.

FIG. 24 is a schematic view of a holding area having agitation vehicles positioned therein.

FIG. 25 is a schematic view of holding area for mixing agricultural input.

FIG. 26 is a schematic view of a holding area for processing agricultural input.

FIG. 27 is a schematic side view of a vehicle carrying a reel to deliver power to the vehicle.

FIG. 28 is a schematic view of a power cord and reel.

FIG. 29 is a schematic view of a conduit housing a cable and an actuator.

FIG. 30 is a schematic view of a cable dispenser.

FIG. 31 is a schematic cross-section view of a conduit with a cable stored therein.

FIG. 32 is a schematic cross-section view of a conduit with a cable stored therein.

FIG. 33 is a schematic view of a cable stored with a conduit.

FIG. 34 is a schematic diagram of a vehicle operating autonomously.

### DETAILED DESCRIPTION

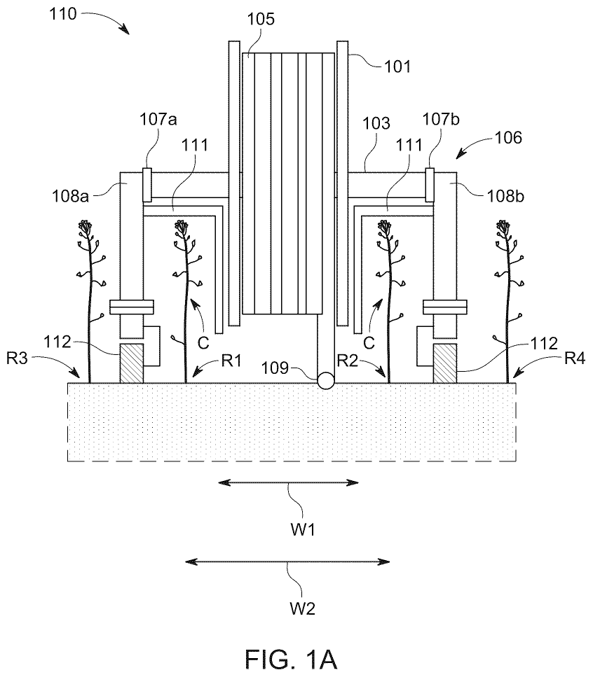

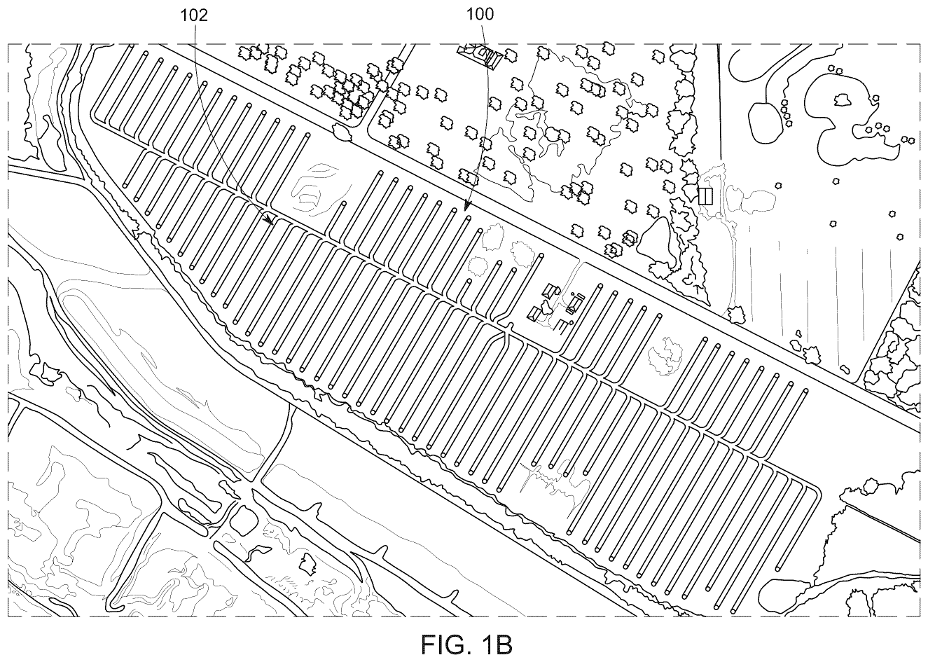

Concepts presented herein relate to use of one or more vehicles in planting and growing crops. One embodiment of a crop input applicator vehicle 110 is illustrated in FIG. 1A, wherein a reel 101 is rotationally supported on a central shaft 103. Shaft 103 connects with a vehicle frame 106, which includes spaced apart supports 108a and 108b. In one embodiment, shaft 103 is supported on frame 106 through bearings 107a and 107b, respectively. Bearings 107a, 107b can take many forms, such as pillow block bearings, slewing bearings or others. Shaft 103 can be supported at a height taller than crops C positioned within a field. Additionally, vehicle frame 106 can be alternatively or additionally mounted on an adjustable carriage to allow its height to be raised and lowered for different height crops. Frame 106 is supported on a plurality of wheel assemblies 112, which can be driven and/or steered to move vehicle 110 as desired. While reel 102 is illustrated as rotating about shaft 103 that is orthogonal to a direction of travel for vehicle 110, shaft 103 can be positioned to be parallel with a direction of travel for vehicle 110. Additionally, a direction of wheel assemblies 112 can change to orient the direction of shaft 103 to be parallel to, orthogonal to or oblique to a direction of travel for the vehicle 110.

As shown in FIG. 1A, the reel 101 can be positioned in a field to rotate between rows of crops R1 and R2. Although illustrated as centrally positioned between supports 108a and 108b, reel 102 may also be mounted off center between supports 108a and 108b. A width W1 of the reel may be equal to or less than a spacing width W2 between the rows R1 and R2 of crop. In one embodiment, width W2 is approximately 30 inches, wherein width W1 is less than 30 inches (e.g., 29 inches, less than 29 inches, between 29 and 25 inches, 25 inches, less than 25 inches). A position of reel 102 with respect to supports 108a and 108b can further be selected to position wheel assemblies 112 between rows of crops. For example, support 108a is positioned between rows R1 and R3, whereas support 108b is positioned between rows R2 and R4.

A flexible conduit (e.g., a hose) 105 carried by the reel 101 is optionally connected to a liquid source through an inlet 109. Water may be supplied to the conduit 105. Additionally, fertilizers and/or chemicals may be supplied. At times, fertilizer is optionally injected into the water flow to provide a controlled mixture of fertilizer and water to a field of plants. Water may be sourced from a ground water well, or pressurized by a pump sourcing water from a stream or river, a standing body of water, or a tank. Manure may also be supplied through the conduit 105 to be applied to the field or mixed at a controlled rate into a flow of another liquid passing through the conduit 105.

In a further embodiment, side shields 111 can be mounted to vehicle frame 106 and positioned along sides of the reel 102 to protect crops as vehicle 110 passes through the crops. In one embodiment, a front and/or rear ends of the shields can be tapered to engage crop and gently push crop to the side.

In some embodiments, the vehicle 110 can operate autonomously or semi-autonomously. During use, the vehicle 110 can include mechanisms to apply seeds for planting and further apply agricultural inputs to a crop after planting. The flexible conduit 105 can be a high-density polyethylene (HDPE) hose connected to a source of agricultural input. Inputs delivered through the conduit 105 may be liquids or dry particulate. The conduit 105 may be a constant diameter throughout its length, or it may vary. The vehicle 110 may be driven by electric motors and supplied by various power sources. Liquid may be applied to the crops through nozzles, drops, or other application devices positioned on the vehicle 110. In other embodiments, a tank can be carried by the vehicle to dispense agricultural input. Discussed below are various features that can be utilized with the vehicle 110. Features discussed with the various embodiments can be included on other vehicles as disclosed herein.

With reference to FIG. 1B, the vehicle 110 may be controlled within a field 100 to follow preset paths 102. In one embodiment, paths 102 may be established by physically positioning a guide element in the field such as a guide wire or guide trench cut in the soil. Alternatively, or in addition, the paths 102 may be global positioning system (GPS) points provided to the vehicles. In one embodiment, the GPS paths may be created by recording the position of a first vehicle as it travels through the field and those paths used by the second vehicle to follow where the first vehicle traveled. The first vehicle may be a seed planter, grain drill, air seeder, tillage tool, UTV, ATV, irrigation vehicle, or another vehicle. The second vehicle may be a sprayer, weeder, irrigation, or other vehicle. In another method, a surveyor may position a GPS receiver at various positions in the field along a desired path and a GPS path generated by connection those points. The paths 102 may be used from season to season or may be recreated at any time within the season while a first vehicle passes through the field. The paths 102 may be generated by recording the path taken by a first vehicle and later corrected by surveying positions along the path with a GPS receiver, using a best fit method to strike a line through the GPS points of the path, or by detecting the position of plants on either side of the path with a tactile or non-contact position sensor and correcting for the cross-track error between the recorded path and the neighboring rows of plants. Paths may also be created by flying over the field with a drone, satellite, other aerial vehicle and measuring the positions of plants as they emerge and selecting paths between the rows of emerged plants for the vehicle to follow.

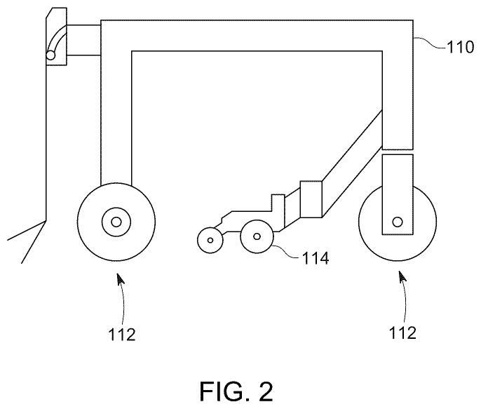

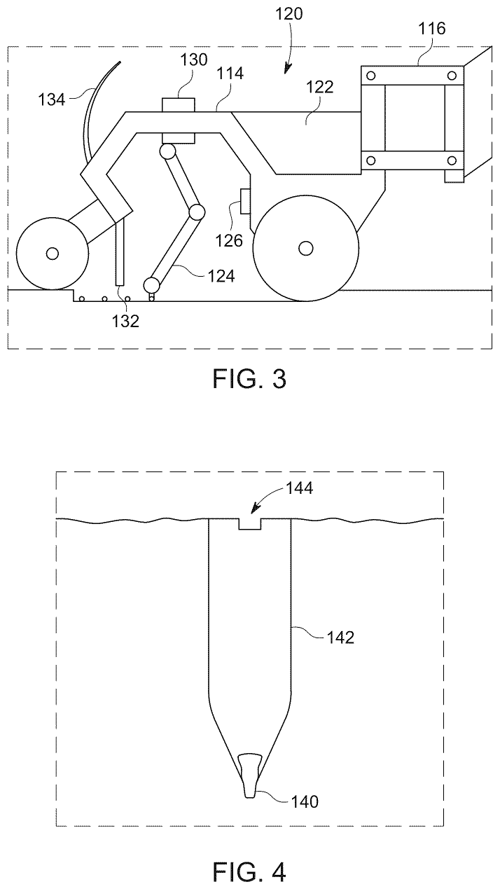

With reference to FIG. 2, one embodiment of a vehicle 110 is illustrated that includes a plurality of wheel assemblies 112 for navigating the vehicle 110 throughout the field. As illustrated, the vehicle 110 can carry one or more seed planting attachments 114 such as row units mounted to the vehicle 110. With additional reference to FIG. 3, one or more row units 114 are mounted to the vehicle 110 on a linkage 116 allowing the row units 114 to follow the topography of the ground.

A seed metering system such as that disclosed in WO 2020/227670A2, entitled “Seed Orientation System for Agricultural Planters”, filed on May 8, 2020, may be mounted to the row unit to plant seeds as the vehicle moves within a field. As shown in FIG. 3, an example seed metering system 120 includes a supply of seed 122. In one embodiment, seeds may be transferred through a seed selection zone by a belt, vibration tray, or other conveyor receiving seed from a seed outlet in the seed supply and returning unplanted seeds back into the seed supply. During operation, individual seeds are evaluated in the seed selection zone by a seed sensor 126 such as a camera, lidar, color sensor, or other sensor capable of detecting the seed's shape and/or orientation. A control system 130 on the row unit 114 can read data from the seed sensor 126, identify one or more seeds in the seed selection zone that match a desired orientation, and direct the planting arm 124 on the row unit 114 to select a particular seed, adjust the position of that seed if needed to match a desired orientation of the seed in the ground as it is planted by the planting arm 124. In one embodiment, the seeds are corn seeds. The seed sensor 126 identifies which seeds have the germ indentation found on one side of corn seeds facing towards the seed sensor 126. In addition, seed sensor 126 can determine orientation of the seeds in the seed detection zone by determining which end of the triangular shaped corn seed is wider and which is narrower. The control system 130 then directs the robot arm to a particular seed with the germ up and adjusts the arm 124 to pick up the seed so that the wide end is oriented up when the seed is placed in the ground by the arm. In one embodiment, a fluid such as water or liquid fertilizer stream may be placed near the seed as it is planted in the ground. Fluid may also be applied to the seed through an application point 132 on the row unit 114 that is sourced through conduit 105 connected with a fluid source.

The seed supply, seed sensor, control system, and planting arm may be used together on a stationary platform to orient seeds and prepare them to be planted later by other methods on the vehicle. Seeds may be oriented to be molded correctly into a cartridge, selectively coated to weight a particular end of a seed, or glued to a seed tape in the desired orientation.

In one embodiment of seed metering system 120 illustrated in FIG. 4, a seed 140 may be oriented in a cartridge 142 made of a fertilizer or other biodegradable material and planted by the planting arm 124. Seed cartridges may be stored in drum magazines or connected together as a belt which is positioned to give the planting arm access to the top of the next seed cartridge to be planted. A sensor or camera on the planter arm 124 reads an orienting feature 144 on the cartridge and aligns the cartridge so the desired orientation of the seed 140 is achieved when it is planted by pressing the cartridge 142 into the soil from the surface.

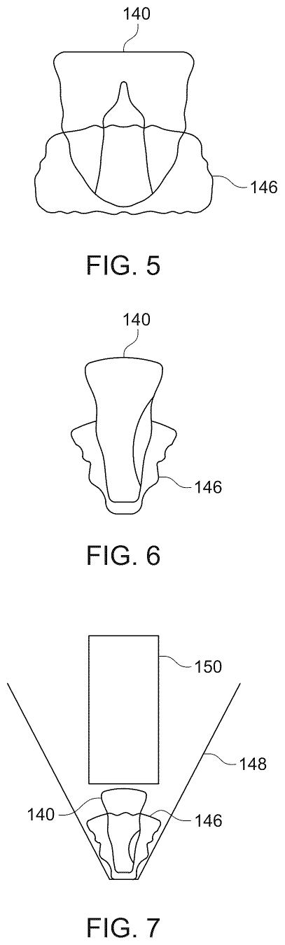

In a further embodiment shown in FIGS. 5-7, a seed 140 can be selectively coated with a bio-degradable or fertilizer coating 146 to weight the seed 140 so that a desired position in the ground is frequently achieved when the seed 140 is planted, for example being dropped through a tube by gravity. In one example, a corn seed is positioned so that the plant embryo is pointed up. The coating 146 can be a bio-degradable material and may be formed in a v-shape. As the seed 140 is dropped in a v-furrow 148, for example created by the row unit 114, gravity pulls on the material side of the seed so that it lands with the material down and the embryo pointing up. A firming device 150 may pass over the seed to shift the position of the seed so that the v-shape of the material on the seed 140 aligns with the v-shape of the furrow 148.

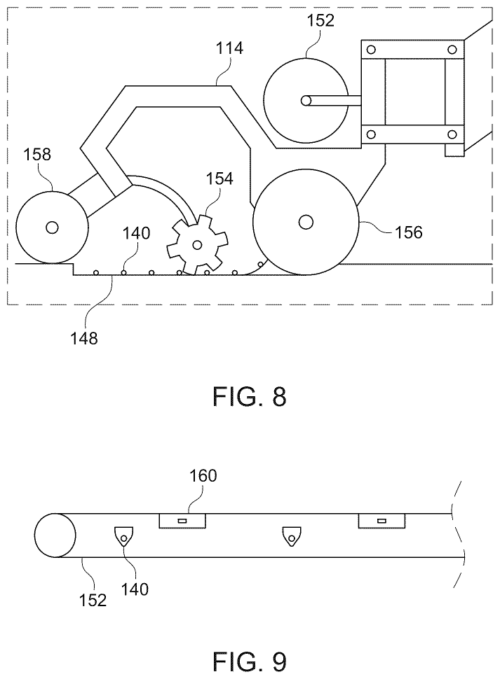

In another embodiment shown in FIG. 8, seeds 140 can be attached to a tape 152 mounted to rotate with respect to the row unit 114 at a consistent spacing matching the desired population and the seeds 140 are oriented within the tape 152 to match a desired position of the seed 140 in the ground. The row unit 114 opens a trench in the soil as it is moved by the vehicle 110 and the tape 152 is metered into the furrow 148 at a speed opposite and equal the speed of the vehicle 110 with the orientation of the tape 152 positioned so that seeds 140 are correctly oriented relative to the soil surface. A tape firming wheel 154 may be used to press the tape to the bottom of the furrow 148 created by a wheel 156. A closing system 158 closes the furrow 148 over the tape 152. In one embodiment, the tape 152 may be made of a material designed to degrade when exposed to the field environment at a rate so that it remains intact throughout the growing season or for a duration more or less than a growing season. Liquid fertilizers, chemicals, or irrigation water may be applied to the soil before, during, and after the tape 152 is placed in the ground. A bio-degradable film may also be applied by the row unit at the surface of the soil to increase the temperature experienced by the seed and increase the speed of germination.

As illustrated further in FIG. 9, tape 152 carrying the seed 140 may be shaped to form a liquid tube. Dispensing locations 160 may be positioned on the tape at a desired frequency to apply water or nutrients to the growing plants throughout the growing season. In one embodiment, an inlet end of the tape 152 at the beginning of the row may be in fluid communication with a supply line at an edge of the field and an outlet end may be sealed. In another embodiment, the vehicle 110 may include drops that connect with each material inlet under the drop and supply water, chemicals, or fertilizers through the tubes. In another embodiment the material is not bio-degradable but is retrieved from the soil by the vehicle at the end of the growing season. In another embodiment the bio-degradable material is a plant fertilizer capable of supplying nutrients to the plant as it degrades.

The row unit 114 described above may alternatively be attached to a vehicle such as a planter, air seeder, tillage tool, sprayer, or combine. The crop may then be irrigated or nutrients may be applied by the agricultural vehicle described herein.

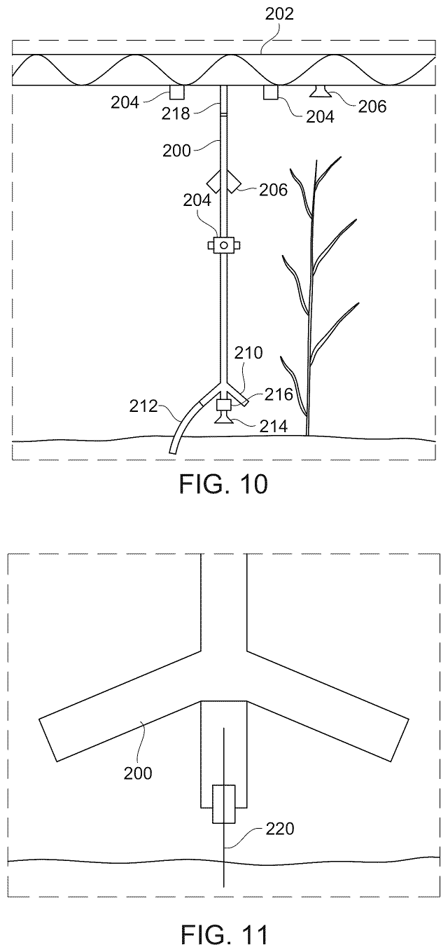

With reference to FIG. 10, to apply agricultural input to crops after planting, a vehicle can include one or more drops such as drop 200 suspended from a boom 202 attached to the vehicle and positioned between rows of plants. In some embodiments, the drop 200 is fluidly coupled with a flexible conduit carried by a reel supported by the vehicle. The drop 200 can include multiple application along a length thereof points to apply various inputs to the crop. For instance, atomizing nozzles 204 may be positioned at various heights on the drop 200 to spray liquid on the crop. Additionally, the boom 202 may support application points such as atomizing nozzles 204 to spray liquid on the crop from the top of the plant.

Sensors 206 can be positioned on the drop 200 and/or the boom 202 to measure attributes of the crop including but not limited to color, normalized difference vegetation index (NDVI), temperature, total biomass, stalk diameter, plant height, plant spacing, plant leaf orientation, nutrient deficiency patterns on leaves, plant growth stage by detecting the number of leaves or other attributes of the plant, ear size, ear silk length and color, pollen quantity, sunlight on the ground, and other agronomic attributes.

Liquid applicator ports 210 can be positioned near the bottom of the drop 200 to apply liquid as a stream at the base of the plant. In some embodiments, extension tubes 212 of varying lengths may be attached to the liquid ports 210 to position the stream closer to the base of the plants. Tubes 212 may be long enough and biased outward to position the outlet of each tube 212 on the ground and next to the plant.

In one embodiment, a deflector 214 can be positioned near the end of the drop 200 to spread cover crop seed or other inputs to be distributed across the ground. Manual valves or electronic valves 216 may be positioned near each application device on the boom 202 and/or drop 200 to select which application point is active at any moment in time. Application devices may be plumbed together to apply the same input or they may be plumped independently to apply different inputs at the same time.

The drop 200 may be attached to the boom through a flexible hose 218 so its position may flex when being pulled between rows of plants. In one embodiment, the base of the drop may be shaped as an inverted T so that the width of the drop causes the drop to stay centered between rows. The drop 200 may also be designed with flexible components so that it may apply as the machine travels forward or reverse.

In a further embodiment illustrated in FIG. 11, the drop 200 may also include a stabilizing component 220 such as additional hoses dragging on the ground or other ground engaging features such as a rolling coulter, sliding blade, or rolling wheel to maintain the position of the drop 200 between rows of plants as the machine travels along a sloped area within a field.

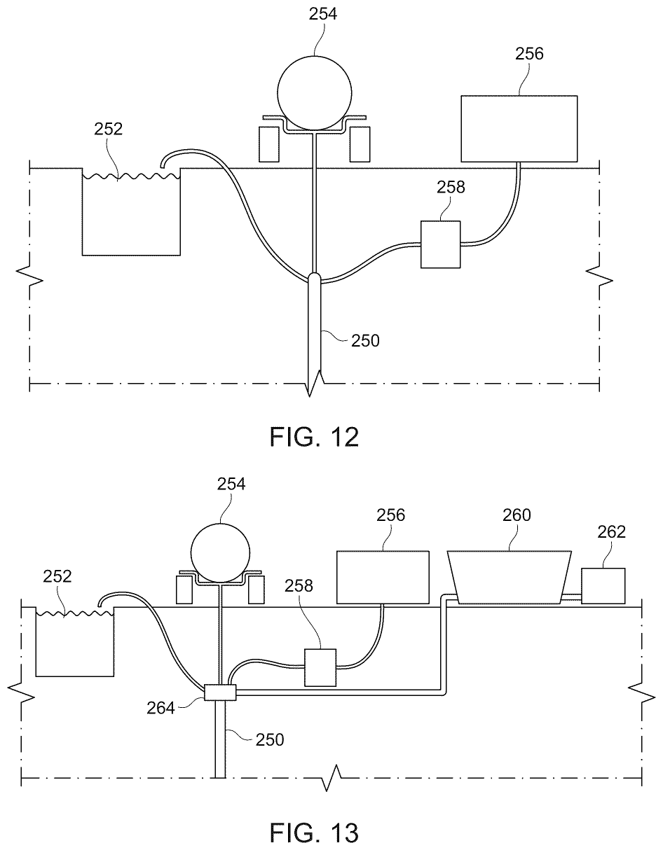

Liquid may be supplied to the vehicle to a flexible conduit 250 connected with the one or more drops (e.g., drop 200) from various sources as illustrated in FIG. 12. For example, water may be sourced from a natural water source 252 such as a well, pond, lake, river or stream. Some water sources such as a pond or lake may be supplied by drainage tile running through the field being irrigated. Liquid such as water, fertilizer, manure, chemicals, or other agricultural liquids may be supplied through the conduit from a liquid truck or trailer 254 traveling between a source location and the field where the vehicle is operating. Water, fertilizer, manure, chemicals, or other agricultural liquids may also be sourced from a storage tank, lagoon, or other container 256 and passed through the conduit directly or injected into a flowing stream of water already passing through the conduit 250. The liquid may be metered into the conduit 250 with an injection pump 258 to a manifold at a controlled rate or the rate may vary based on a prescription managed by a control system or by measurements collected by an environmental or plant sensor.

In addition to liquid, the conduit 250 may be connected to a dry particulate source 260 as illustrated in FIG. 13. In this embodiment, a dry material distribution manifold on the vehicle is configured to apply dry particulate to a field. The dry particulate may be a fertilizer, seed, pollen, or other granulated chemical applied to a crop. A pressurized air source 262 is connected to the supply side and the dry particulate is metered into the conduit at a rate to match the desired application rate for the location of the vehicle in the field. The operator may set a target rate, or it may be determined by taking a measurement with an environmental or plant sensor and comparing the measurement to a desired threshold. The conduit 250 may be selectively connected to one or more liquid sources and one or more dry sources. A switching valve 264 positioned at an inlet of the conduit 250 may allow the operator to select between sources to apply while the vehicle moves through the field. The switching valve may also be operated off a prescription defining where each source should be applied in the field. The valve 264 may also be driven by the controller on the vehicle and the source changed based on the measurements of an environmental sensor detecting the need for a certain source to be applied to an area. Pressurized air from source 262 may be used to clean the conduit when switching to a new source or a liquid may be used to flush the conduit 250. A cleaning material such as a detergent may be supplied to the switching valve 264 and used to clean the conduit.

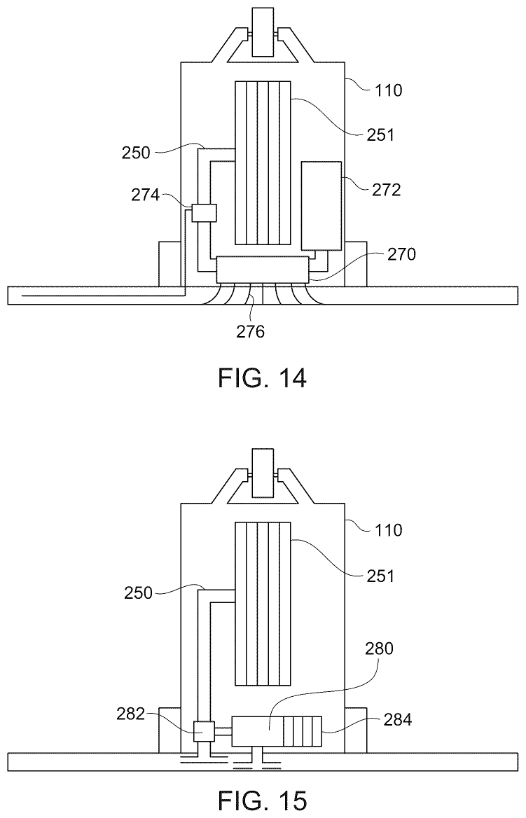

Alternatively, as illustrated in FIG. 14, a dry particulate manifold 270 may be mounted to the vehicle 110 and connected to the conduit 250 mounted on a reel 251. Manifold 270 is fluidly coupled to a dry particulate source 272 carried on the vehicle 110. The manifold 270 may be optionally connected to a switching valve 274 on the vehicle that is connected to the conduit and capable of directing liquid down one application path and directing dry particulate to the manifold 270. Dry particulate should be evenly divided by the manifold and routed through hoses 276 to a dry application point on the vehicle. Drops can be mounted to a boom and connected to the dry manifold 270 through the hoses 276. The drops may be positioned to apply a dry particulate near the plant or in the middle of the row. In one embodiment, a deflector is mounted to the end of the drop to evenly spread dry particulate across the ground.

In addition to other features, a concentrate injection system 280 as shown in FIG. 15 may be carried by the vehicle 110. A valve 282 may be positioned to divert a portion of the total liquid flow from the conduit 250 through the concentrate injection system 280 while the remaining flow continues to the original application points. The concentration injection system 280 may store one or more chemical, pollen, or nutrient concentrates 284 that may be metered into the diverted liquid stream at a rate to create a desired mix to be applied to the crop.

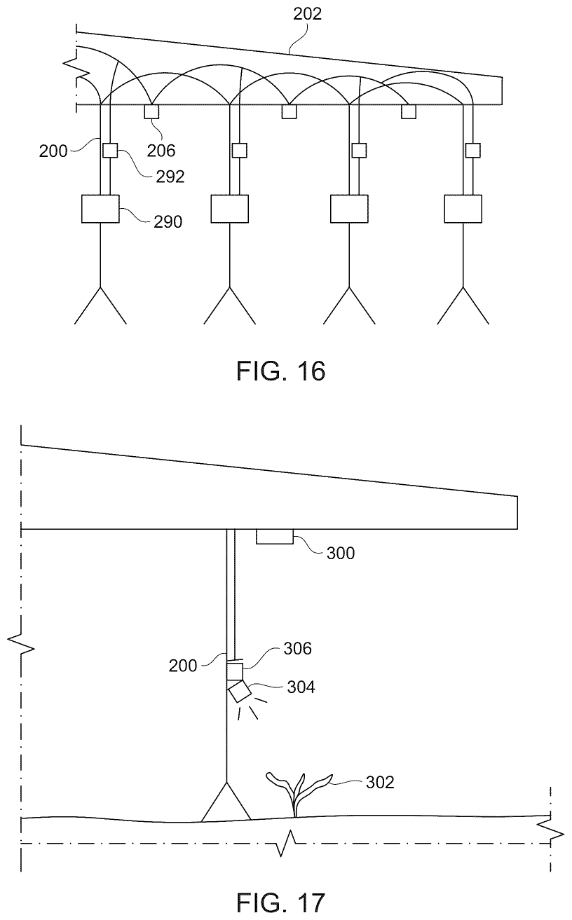

As shown in FIG. 16, the mixed stream from the concentrate injection system 280 is pumped to various application points to be applied to a crop. In one example, the primary stream of liquid may be water used to irrigate a crop through drops 200 mounted on boom 202 and the diverted stream is mixed with a fungicide concentrate and applied to the leaves of the crop through atomizing nozzles 206 mounted on the boom. The mix rate of concentration may be set by the operator or adjusted based on the measurements of an environmental sensor detecting the presence of a pest, weed, disease or other crop factor requiring the application of a concentrate. In another example, a nozzle body with multiple atomizing nozzles 290 is positioned in a crop and paired with an atomizing nozzle 206 on a boom to coat the top and bottom of leaves on a plant. As the vehicles moves ahead, pulsating valves 292 such as a solenoid, voice coil, or rotating ball valve, may be positioned in the stream to pulsate the flow to the atomizing nozzles so that the concentrate mix is applied while the plant is in the application zone created by the nozzles and turned off when no plant is in the zone. A plant sensor may be used to detect the presence of a plant in the application zone.

In another embodiment illustrated in FIG. 17, a spot spray system may be mounted to the vehicle to selectively spray weeds with a concentrate mix. A plant sensor 300 may be used to detect the location of a weed 302 as it passes into the application zone of a nozzle 304. A pulsating valve 306 in communication with the plant sensor may be used to momentarily send flow through the nozzle to spray the concentrate mix on the weed at the location detected by the plant sensor.

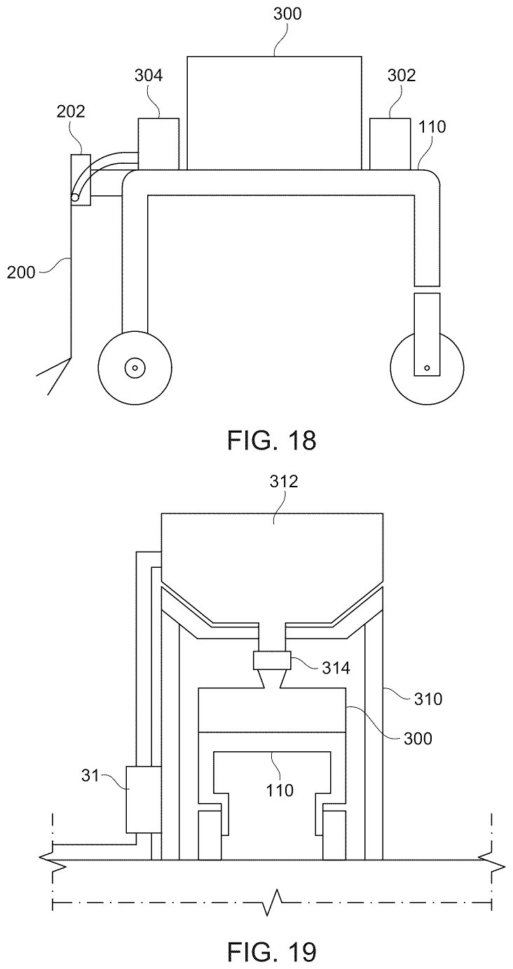

In alternative embodiments, the conduit or hose 250 may be eliminated from the vehicle 110. As shown in FIG. 18, the vehicle 110 may carry an input tank 300. The vehicle 110 may be powered by a generator, diesel engine or other power source 302. The vehicle 110 may be moved from field to field or remain in one field throughout a growing season. The vehicle 110 carries a pump system 304 supplied by the tank and applies inputs stored into the tank to a crop. The application may be made using drops 200 or nozzles supported by boom 202 or from a rotating irrigation gun mounted to the vehicle 110.

The input tank 300 may be filled at a filling station 310 shown in FIG. 19. Liquid may be supplied to the filling station from any of the liquid sources described herein including wells, ponds, lagoons, rivers, tanks, or other sources. As the vehicle 110 is positioned in the filling station 310, the inlet of the input tank 300 may be positioned under a supply tank 312 in the filling station and a valve 314 opened in the supply tank 312 to allow gravity to dump liquid from the supply tank 312 into the input tank 300 on the vehicle 110. The size of the supply tank 312 may be designed to match the size of the input tank 300. Alternatively, the vehicle 110 may dock to the filling station and liquid may be pumped from the supply tank 312 to the input tank 300 or directly from the liquid sources into the input tank 300.

A docking system as described in PCT Pat. App. No. PCT/US18/39372, filed on Jun. 25, 2018, entitled Crop Input Supply System, Methods and Apparatus, a copy of which is appended hereto, may be used to connect the vehicle and fill station. As the vehicle applies liquid to crop, the supply tank 312 is refilled by pumping liquid from the sources to prepare for when the vehicle returns. The concentrate injection system 280 described herein may be mounted to the filling station and concentrate injected into liquids placed into the supply tank so that a mix of inputs including water, manure, chemicals, nutrients, pollens, or other inputs may be applied to the crop.

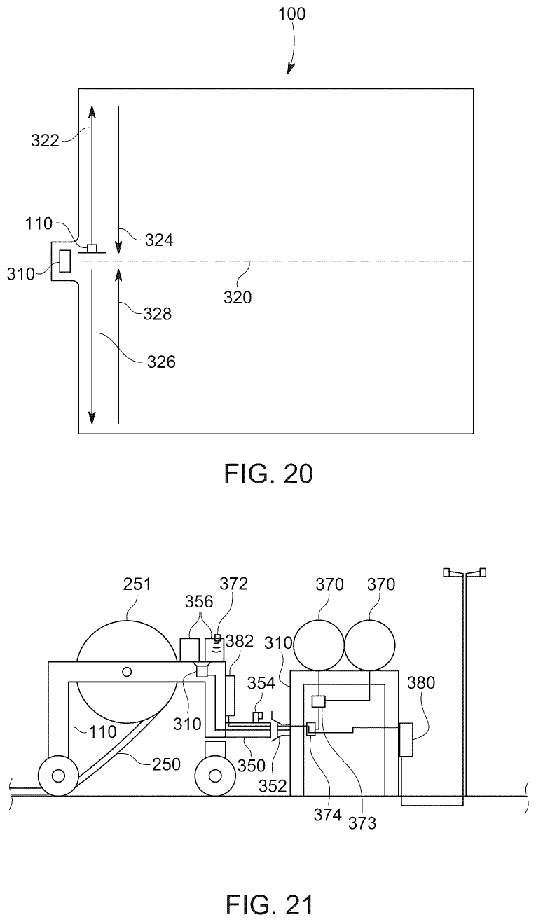

The size of the input tank 300 on the vehicle 110 may be selected to match an amount commonly applied to an area of the field such that the vehicle will be empty as it arrives back to the filling station. As shown in FIG. 20, the vehicle may carry enough liquid to apply to two passes in the field from a supply path 320 positioned in the field 100. As the vehicle drives away from the supply path 320 along a first application path 322 and then returns along a second application path 324, the input tank will be empty. Then the vehicle 110 returns to the filling station 310 along the supply path 320 to reload the input tank to apply to a third application path 326 and a fourth application path 328. The vehicle 110 then drives back out the supply path 320 to arrive at two new passes and begins to apply again. The amount of area that can be applied per fill of the input tank can be varied by the desired rate to be applied or by the size of the input tank carried by the vehicle 110. In some low rate applications, the input tank may be large enough to only require one fill for a field and the vehicle 110 may be moved to a new field to follow the same process there. Alternatively, multiple filling stations 310 may be positioned in a field 100 at locations where they may be easily reached by the vehicle 110 when it is empty to minimize the time spent by the vehicle driving along the supply path.

As illustrated in FIG. 21, a docking boom 350 may be mounted on the vehicle 110 positioned to connect to a supply connector (herein in the shape of a funnel) 352 connected to a loading or fill station 310 placed in the field. The docking boom 350 and funnel 352 may be reversed where the funnel is on the vehicle 110 and docking boom on the fill station 310. A docking system and related components as described in PCT Pat. App. No. PCT/US18/39372, filed on Jun. 25, 2018, entitled Crop Input Supply System, Methods and Apparatus, a copy of which is hereby incorporated by reference, may be used to connect the vehicle 110 and fill station 310. A control system on the vehicle may use a camera, color sensor, or other proximity sensor 354 to detect the position of the boom 350 relative to the connector 352 as the vehicle 110 drives forward and align the boom 350 with the connector 352 until the connection is made. Once the connection is made, a new supply of agricultural input is transferred through the boom 350 into input containers 356 on the vehicle 110.

Fertilizers, fuel, herbicides, pesticides, fungicides, biologicals, plant pollen, or other inputs may be supplied through the boom 350 and directed to different input containers by a corresponding switching valve 373 on fill station 310. The fill station 310 may be positioned at the edge of the field for easy access by the operator or an input supplier. Fill station 310 may support one or more storage containers 370 in fluid communication with the connector 352 through the switching valve 360. When a control system on the vehicle 110 detects the level of an input has reached a low limit threshold as detected by a container level sensor 372, the vehicle 110 is driven to the loading station, docked, a master valve 374 is opened, the switching valves 360 on the vehicle 110 and switching valves 373 on fill station 310 are set to a desired storage and input containers, the input is refilled through gravity flow or a pumping system until the input container 356 is full, and the vehicle 110 returns to the last field location to resume operation.

In addition to a fluid connection, an electrical connection may be made through the boom 350 and connector 352. In one embodiment, a power source 380 is connected to the fill station 310 and provides power through an electrical connector coupled with the connector 352. In one example, a mating electrical connector is positioned on the boom 350 to align with the corresponding electrical connector when docked to the connector 352. An input may be transferred through the connector 352 to the boom 350 while the power source 380 simultaneously provides power to the vehicle 110. Batteries 382 stored on the vehicle 110 may be charged and used to power the vehicle 110 in between charges at the fill station 310.

In one embodiment, the control system detects the charge level of the batteries 382 and calculates a remaining amount of distance that the vehicle 110 can travel before recharging. As the remaining amount of distance approaches a travel distance to the fill station 310, the control system records the last application location of the vehicle 110 and drives it to the fill station 310 to recharge. After charging, the control system returns the vehicle 110 to the stored location and resumes operation. In another embodiment, an electrical connection may be made through a second boom and funnel while inputs are transferred through the first. In another embodiment, the vehicle and loading station swap batteries to resupply the vehicle with a charged battery and to place the empty battery on the loading station to recharge while the vehicle is away.

In another embodiment, the fill station is a mobile supply vehicle. The mobile supply vehicle may carry supply batteries to provide power to the vehicle 110 or it may connect to the utility service at the edge of the field. It may also carry one or more storage containers to supply inputs to the vehicle.

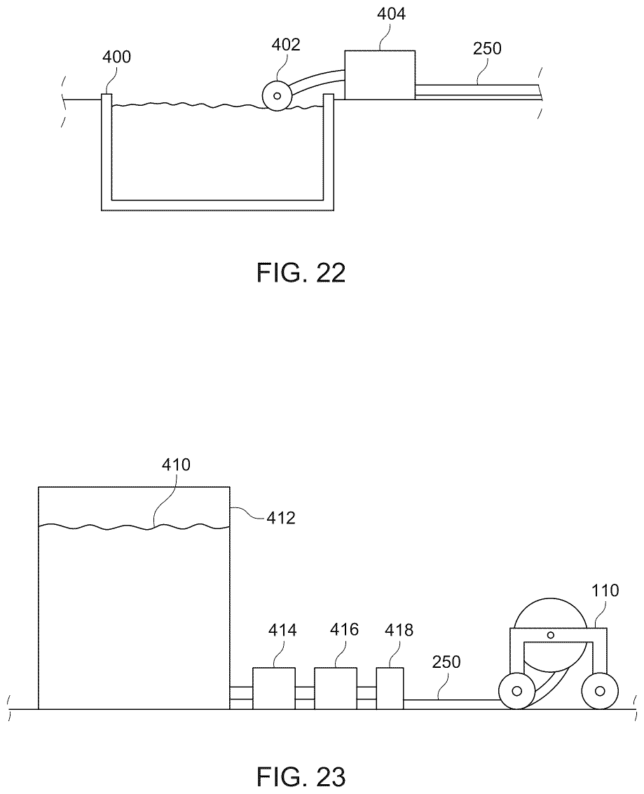

Several different approaches to delivering agricultural input to conduit 250 can be utilized as described herein. As illustrated in FIG. 22, for example, manure may be applied to a growing crop through the vehicle 110 by connecting the conduit 250 to a manure source 400. The manure source may be a lagoon, confinement building, mobile tanker, or other source. A filter 402 may be positioned at the inlet of a pump 404 to trap solids larger than the smallest outlet positioned in the system. The filter may be centrifugal, a rolling screen, or other filter style. The pump 404 may be positioned near the source to pressurize manure and push it through the conduit 250 to the vehicle 110 and through application points on the vehicle 110 to apply the manure to a crop. The manure may be mixed with water from a water source such as a well to dilute the manure to a desired concentration. In one method, the manure is tested to determine its nutrient level and water added at a rate to lower the concentration to a nutrient level desired to be applied to the crop.

In another embodiment, as shown in FIG. 23, an agricultural input 410 such as fresh water, manure, agricultural or industrial wastewater, dry or liquid nutrients, agricultural lime, or other materials and/or combinations thereof applied to agricultural fields may be stored in a holding area 412. The holding area may be a storage tank, lagoon, mobile tanker, or other container. The agricultural input may be stored at a site separate from the field where it will be applied, or it may be stored in the field. When the agricultural input is manure, the holding area may be under the livestock housed in a confinement facility or manure may be transferred by a scraper or pumping system into an area away from the livestock.

The agricultural input may be pumped from the holding area to one or more application vehicles through a conduit 250 such as a soft hose, lay-flat hose, drag hose, solid pipe laid on the surface or buried underground, a conduit stored on a reel that may be mounted on an application vehicle or remain stationary and be positioned to supply a drag hose to an application vehicle, or a combination of these or other conduits. The agricultural input may also be loaded into a transport vehicle and moved to a local holding area to be supplied to an application vehicle. In another embodiment, the agricultural input may be loading into a transport vehicle, moved, and unloaded into a container on an application vehicle not connected to a conduit.

A filter 414 may be installed at the outlet of the holding area to capture any particles in the agricultural input that would be large enough to cause a blockage in the conduit and/or the application vehicle. The filter may a rolling screen, centrifuge, stationary screen, or other filter. The filtered liquid may then be supplied to a pump 416 to push to the application vehicle through the conduit or to fill a transport vehicle.

A chopper pump 418 such as those manufactured by Vaughan Co., Inc. in Montesano, Wisconsin may be positioned at any point along the conduit between the holding area and the application vehicle to reduce the size of any solids in the agricultural input so that they are able to pass through the conduit and application vehicle without causing a blockage.

The application vehicle 110 may be an injection bar, manure spreader, agricultural sprayer, tillage tool, seed planter, irrigation system or other agricultural machine.

The agricultural input may be supplied to the application vehicle directly through the conduit or it may be mixed with a dilution liquid such as water from a source near the holding area prior to passing through the conduit. In another embodiment, the agricultural input may pass through a portion of the conduit and then be mixed with a dilution liquid from a source in the field where the agricultural input is applied.

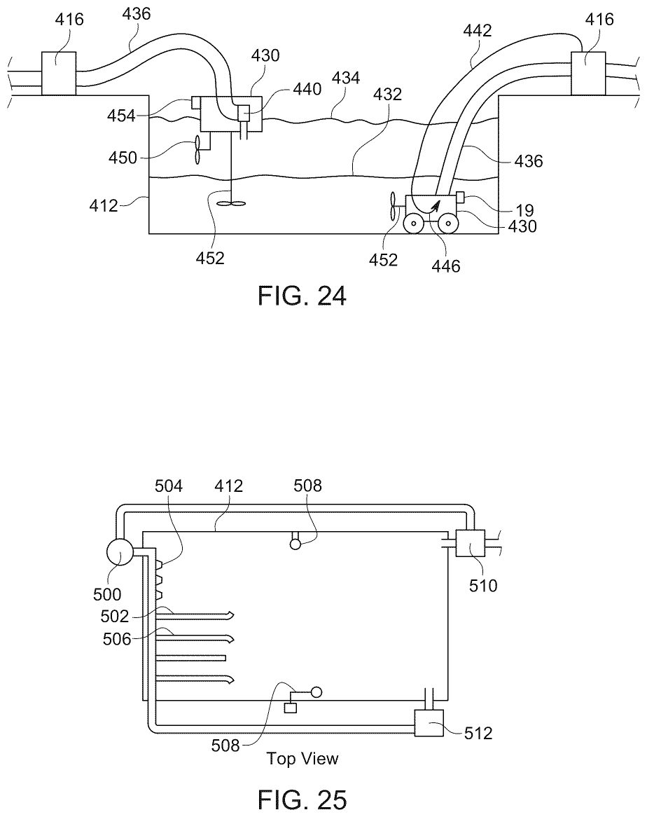

As illustrated in FIG. 24, an agitation vehicle 430 may be placed in the holding area 412 to locally mix solids 432 and liquids 434 in a portion of the holding area and send the mixed liquid through a supply hose 436 to a pump 416 that delivers the agricultural input through the conduit 250 to the application vehicle 110. The agitation vehicle 430 may carry a supply pump 440 to send mixed liquid through the supply hose 436 or it may be connected to a jet hose 442 to run a jet syphon nozzle 446 at the inlet of the supply hose 436. The supply hose 436 may be mounted to a supply hose reel to extend and retract hose to the agitation vehicle 430 as it moves in the holding area. Alternatively, extra length of supply hose 436 may be added to the holding area and drug by the vehicle as it moves in the holding area. The agitation vehicle 430 may be powered by a battery, electric cord, or by the flow of liquid through the jet hose turning a turbine to directly move the vehicle or to generate electricity used to run the agitation vehicle. The agitation vehicle 430 may float on the surface of the agricultural input as is shown on the left side of FIG. 24 or it may be submerged as is shown on the right side of FIG. 24. The agitation vehicle 430 may move by turning propellers 450, by directing nozzles of pressurized air or agricultural input, or by driving along the lower surface of the holding area. The agitation vehicle 430 may also be suspended on cables positioned to move the vehicle in a cartesian x and y pattern around the holding area 412. The vehicle 430 may support mixing features 452 such as propellers, screws, augers, or other structures used to locally stir solids and liquids together.

The agitation vehicle 430 may contain a position sensor 454 such as sonar or other sensor to detect when the vehicle is approaching the boundary of the holding area. The agitation vehicle can be controlled to change in a random direction when it approaches a boundary, or it may follow control paths to cover the entire area of the holding area.

As shown in FIG. 25, a dilution liquid, from one or more dilution liquid sources 500 such as a water tank or water well, may be added to the holding area 412 to dilute the agricultural input to a desired concentration. In one example, the agricultural input within the holding area 412 is livestock manure, and the dilution liquid is water that is added to the holding area to dilute the manure to a desired concentration. The desired concentration may be determined by measuring the nutrient value of the manure and by determining the water need for a crop where the combined liquid will be applied, and then adjusting the manure to water ratio to simultaneously meet the nutrient and water needs of the crop. The dilution concentration may alternatively be determined as the level required to cause the viscosity of the agricultural input to be low enough to pass through the conduit 250 to the application vehicle 110.

The dilution liquid from a dilution source may be pumped through one or more injection ports 502 in the holding area 412 to stir the agricultural input and cause any solids in the agricultural input to become agitated and mixed into the liquid. The liquid ports 502 may be below the surface of the agricultural input to minimize the incorporation of air or they may be above the surface to cause more aggressive stirring of the mix. The liquid ports may be short nozzles 504 or may be tubes 506 extending into the agricultural input. One or more liquid level sensors 508 such as floats attached to angle rotation sensors or ultrasonic surface level sensors may be mounted in the holding area to measure the original amount of agricultural input and the final mixed liquid level to determine that the desired concentration has been reached.

The agricultural input may be at a level in the holding area that is too full to hold the dilution liquid needed to achieve a desired concentration. A mixing valve 510 at the outlet of the holding area may be used to source a portion of agricultural input from the holding area while sourcing the other portion directly from one or more dilution liquid sources to achieve the desired concentration. In one example, manure and water may be mixed in the holding area to a level achievable to fit inside the total capacity of the holding area and additional water may be added in the mixing valve to achieve the desired concentration of manure and water being sent to the application vehicle through the conduit.

A mixing pump 512 may be used to further stir the mixed liquid in the holding area. Liquid from the holding area may be supplied to the mixing pump and returned into the holding area through one or more injection ports 502. The injection ports 502 may be those used to inject dilution liquid into the holding area or may be separate ports positioned to maximize the stirring of liquid in the holding area.

As the final application is made to the field during a growing season of a crop, the holding area may be emptied to maximize the available storage of agricultural input during the offseason. The amount of mixed liquid in the holding area may be measured by the level sensors and compared to the total amount to be applied to the crop. The amount of dilution may then be adjusted so that the total amount in the holding area is less than or equal to the amount to be applied in the final application.

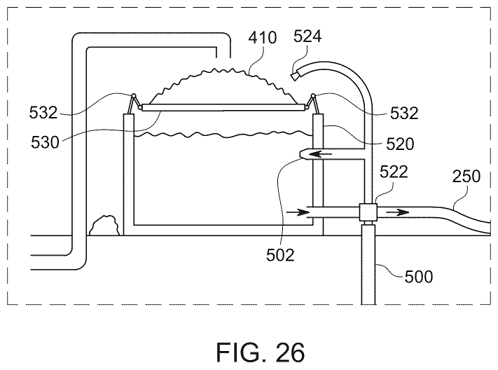

As shown in FIG. 26, one or more agricultural inputs may be stored in a local holding area 520 in the field where it will be applied. The local holding area 520 may be a storage tank, frac tank, pit, lagoon, or other container. Agricultural input 410 is transported to the local holding area in a transport vehicle or pumped through a conduit connecting the local holding area to one or more other holding areas. One or more dilution liquid sources 500 such as a water well may be positioned near the local holding area and connected to supply dilution liquid to be mixed with the agricultural input in the local holding area. One or more local holding areas may be connected to the same application vehicle through a common conduit or one or more chambers may be used within the local holding area to allow one or more agricultural inputs 410 to be applied simultaneously. In another embodiment, two or more agricultural inputs are added to the local holding area at the same time and mixed in the local holding area.

In some embodiments, the agricultural input 410 may be metered directly from the local holding area into a flow of dilution liquid passing through the conduit 250 to the application vehicle. In other embodiments, all or a portion of the dilution liquid is added to the local holding area and mixed with the agricultural input to match a desired concentration. The desired concentration may be set to match the input needs of a crop or may be set to lower the viscosity of the agricultural input so that it can flow through the conduit and application vehicle.

A mixing pump 522 may be used to further stir the mix of agricultural input and dilution liquid in the local holding area. Liquid from the holding area may be supplied to the mixing pump and returned into the holding area through one or more injection ports 502. The injection ports 502 may be those used to inject dilution liquid into the holding area or may be separate ports positioned to maximize the stirring of liquid in the holding area. The mixing pump 522 may include valves to change the direction of flow between the dilution source 500, local holding area outlet, injection ports 502, and spray nozzles 524.

A filtration system 530 may be added to the local holding area to remove particles that are too large to pass through the conduit and application vehicle without causing a blockage. In one embodiment, a filter may be positioned at the inlet of the local holding area and agricultural input is placed on the filter from the transport vehicle or conduit supplying agricultural input to the local holding area. Load cells 532 or other weighing sensors may be positioned to measure the amount of agricultural input on the filter. The filter may be a metal or plastic mesh, a fabric filter, or other filter material. The filter may be shaken or vibrated to cause the agricultural input to shift and pass through the filter. Particles that are too large are then shaken off the end of the filter and piled. Alternatively, spray nozzles 524 connected to the dilution liquid source or the mixed liquid in the local holding area may be positioned above the filter to carry the agricultural input through the filter and to cause the particles that are too large to be carried by the liquid off the end of the filter. Spray nozzles may be used in place of or in conjunction with the shaking of the filter. A mechanical scraper may also be positioned to run along the surface of the filter at a periodic interval to scrape large particles off the filter and prepare to receive a new supply of agricultural input.

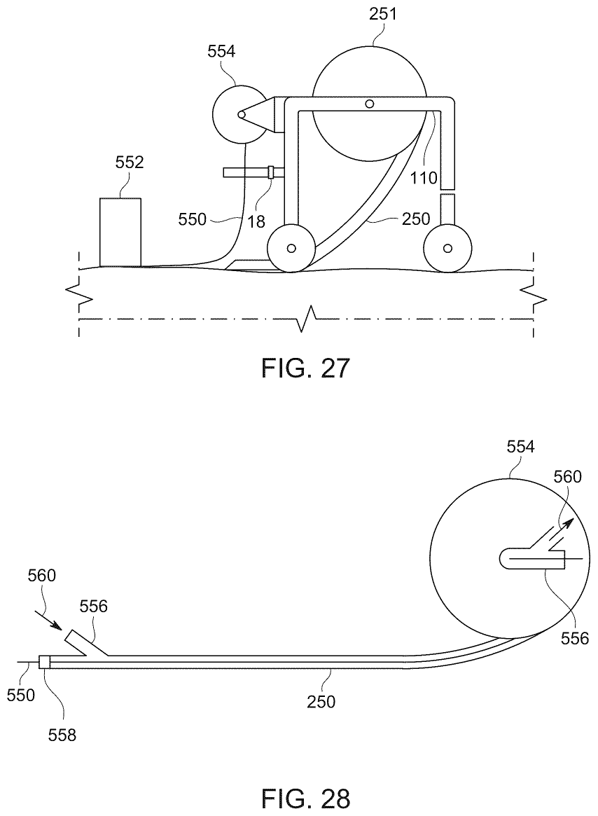

Vehicles described herein can be powered in various ways. In one embodiment, the vehicle 110 is powered from a remote source through a cable carrying power from the source to the vehicle. As shown in FIGS. 27 and 28, a cable 550 containing one or more wires may be carried in the conduit 250 with the agricultural input being applied. A cable entry point and exit point are provided at each end of the conduit to allow the cable 550 to exit the conduit 250 through a sealed point that prevents the input from escaping. Cable 550 is connected with a power source 552 and connected to vehicle 110 through a reel 554. In one embodiment, the entry and exit points to conduit 250 are wye or T-fittings 556 and the cable passes through a sealed cap 558 on one side of the wye and the flow of input continues through the other portion 560. The cable may exit the outlet of the conduit 250 at the reel 554 by passing through the center point of the reel rotation axis. In one embodiment, a slip ring or other rotary electrical contact is mounted to an end of the reel rotation axis and the cable is wired to one ring while the electrical system of the vehicle is wired to the other ring so that electricity passing through the cable is passed through the slip ring and used to power the vehicle.

In an alternative embodiment, a gripping assembly having one or more gripping device can be included to control positioning cord onto and off of the reel 554. In one embodiment, the gripping assembly includes rollers positioned adjacent one another that are configured to grip the cord. In a further embodiment, a tension sensor can sense a position of the cord. In yet a further embodiment, an angle sensor can be positioned to measure a position of the cord relative to the vehicle. If the cord is not being dispensed quickly enough while the vehicle is moving forward, the cable will be slightly pulled and lift the angle sensor. This adjustment will speed up the gripping devices which raising the tension on the tension sensor which should speed up the reel. If the cable is being dispensed too quickly, the angle sensor will drop, lowering the tension, which lowers the reel speed and the cable will again lift the angle sensor to the desired position. The reverse would apply if the vehicle is moving backwards.

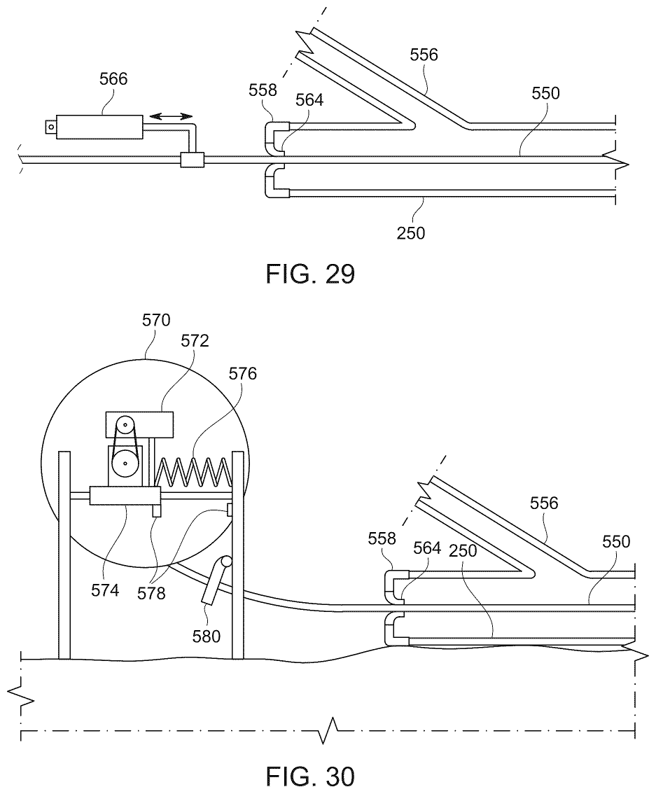

In another embodiment shown in FIG. 29, a cable tensioner system is mounted near the entry end of the conduit and designed to manage the tension of the cable 550 and control its position within the conduit 250. The flow of input passing through the conduit will shift the slack of the cable towards the outlet of the conduit as it is dispensed off the vehicle. If the slack of the cable is not managed, the turning of the reel may cause the cable to be stretched and damaged within the conduit. To manage the tension, the cable passes through a cable seal 564 such as a lip seal that allows the cable to slide in and out of the conduit without the agricultural input escaping. A tension source 566 such as a tension spring, coil spring, air spring, air cylinder, hydraulic cylinder, or other tensioner is connected to the cable 550 and positioned to apply tension to the cable 550 along its length through the conduit 250. The force applied by the tension source should be greater than the force created by the flow of the agricultural input acting on the cable to prevent the slack in the cable 550 from being pushed to the outlet end but less than the force that would damage the cable 550. As conduit 250 is wrapped or unwrapped at the reel 251, the cable 550 may slide in and out of the conduit by flexing the tension source thus preventing the cable from being over tensioned and damaged. Optionally, the cable may be constrained in a small conduit while passing through the cable seal 564 so that the consistent diameter of the small conduit is used to ensure more consistent sealing.

As illustrated in FIG. 30, the cable 550 may be tensioned and stored on a cord or wire reel 570. The reel 570 may be positioned near the conduit inlet location and aligned with the entry point of the cable 550 into the conduit 250. The reel 570 may provide tension to the cable 550 through a coil spring on the wire reel or its rotation may be controlled by a motor 572 and the tension in the cable measured by the torque on the motor changing as the tension changes. The reel 570 may also be positioned on a movable track 574 and positioned against a spring 576 with a known force curve. As the tension in the cable 550 increases, the length of the spring is compressed. The length of the spring may be measured by a sensor 578 such as an ultrasonic distance sensor and the motor controlled to turn the reel to maintain the length of the spring thus maintaining a desired tension in the cable 550. The position of the cable 550 may be controlled by a traverser 580 positioned to align the cable next to previous wraps created on the reel as the cable is wound up.

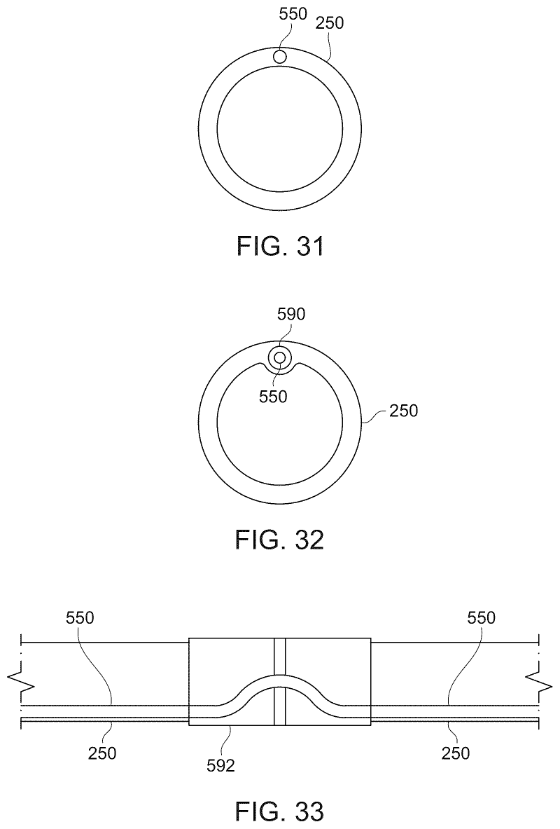

As shown in FIG. 30, the cable 550 may be molded into the walls of the conduit 250 to continuously constrain the position of the cable relative to the conduit. Alternatively, as illustrated in FIG. 31, a cable channel 590 may be molded into the conduit and the cable 550 loosely held in the channel while the input passes through the main conduit. As illustrated in FIG. 33, the cable 550 may also be periodically constrained at points along the length of the conduit 250. The cable 550 may be routed through a portion of conduit and then a section of conduit added that includes one or more cable retention points 592 (e.g., anchors or the like) and that pattern repeated until the desired length of conduit and cable are assembled.

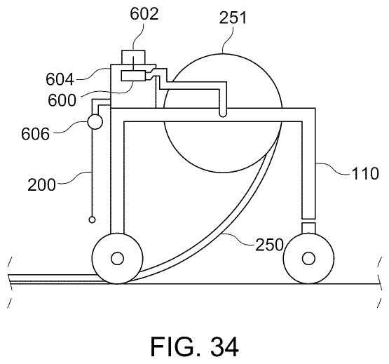

In another embodiment shown in FIG. 34, the vehicle 110 may be powered by generating electricity through the flow or pressure of liquid provided through conduit 250. As liquid flows through the conduit 250, it passes through a hydropower turbine 600 such as a Pelton wheel, Kaplan turbine, Francis turbine, or other turbine design. The turbine turns a generator 602 to provide power to the vehicle. In some embodiments, the turbine is mounted at the top of the vehicle inside a pressure vessel 604 and the liquid exits the turbine at a lower pressure and gravity flows from the pressure vessel 640 through a manifold 606 across a boom to application points 200 on the machine mounted lower than the turbine.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A power cord positioning device in an irrigation vehicle having a reel supporting a flexible conduit such that the conduit can be extended from or retracted onto said reel, the power cord positioning device comprising a cap positioned at one end of the conduit, the cap allowing passage of the power cord and preventing passage of crop input.

2. The power cord positioning device of claim 1, further comprising a cable tensioner system coupled with the power cord.

3. The power cord positioning device of claim 2, wherein the cable tensioner system includes a tension source.

4. The power cord positioning device of claim 1, further comprising a cord reel supporting the power card such that the power cord can be extended from or retracted onto said cord reel.

5. The power cord positioning device of claim 4, wherein the cord reel includes a traverser configured to position the cord with respect to the reel.

6. The power cord positioning device of claim 4, further comprising a sensor configured to sense a position of the cord with respect to the reel.

7. The power cord positioning device of claim 1, further comprising a plurality of retention points securing the cord to the conduit along a length of the conduit.

8. A crop input application system, comprising:
an irrigation vehicle having a reel supporting a flexible conduit such that the conduit can be extended from or retracted onto said reel;
an injection pump fluidly coupled with the conduit and configured to supply liquid to the flexible conduit; and
an application device fluidly coupled with the flexible conduit and configured to apply the liquid to crops.

9. A crop input application system, comprising:
an irrigation vehicle having a reel supporting a flexible conduit such that the conduit can be extended from or retracted onto said reel;
a particulate source fluidly coupled with the flexible conduit;
a pressurized air source coupled with the conduit and configured to supply particulate from the particulate source to the flexible conduit;
an application device fluidly coupled with the flexible conduit and configured to apply the particulate to crops.

10. The system of claim 9, wherein the particulate source is mounted to the vehicle.

11. The system of claim 9, wherein the irrigation vehicle further includes a deflector applying the particulate to crops.

12. The system of claim 9, further comprising a switch valve configured to selectively provide the particulate to the conduit.

13. The system of claim 9, wherein the vehicle further includes a boom and wherein a plurality of atomizing nozzles are mounted to the boom.

14. The system of claim 13, further comprising at least one pulsating valve fluidly coupled to at least one of the plurality of atomizing nozzles.

15. The system of claim 13, further comprising a sensor configured to sense presence of a weed, wherein the pulsating valve operates to deliver a concentrate mix to the weed.

16. The system of claim 13, further comprising one or more sensors coupled with the vehicle to detect one or more conditions of the ground and wherein a controller operates the application device to deliver particulate to crops based on the one or more detected conditions.

17. A crop input application system, comprising:
a vehicle supporting a vehicle tank; and
a refilling apparatus configured for selective fluid coupling to the vehicle tank.

18. The crop input application system of claim 17, wherein the refilling apparatus includes a refilling station including a supply tank, the vehicle configured to interface with the supply tank to fill the vehicle tank.

19. The crop input application system of claim 18, wherein the supply tank is configured to be positioned above the vehicle and wherein gravity operates to deliver fluid from the supply tank to the vehicle tank.

20. The crop input application system of claim 17, further comprising a supply vehicle having a supply tank, the supply vehicle operable to connect with the vehicle tank to deliver fluid from the supply tank to the vehicle tank.

21. The crop input application system of claim 17, wherein a size of the vehicle tank is selected based on a size of a field for application.

22. An irrigation vehicle, comprising:
a vehicle frame configured to traverse a field;
an application device configured to apply liquid to crops; and
a planting device connected to the vehicle frame and configured to plant seeds as the vehicle traverses the field.

23. The irrigation vehicle of claim 22, further comprising a linking connecting the planting device to the vehicle frame.

24. The irrigation vehicle of claim 22, wherein the planting device includes a planting arm articulating with respect to the vehicle frame.

25. The irrigation vehicle of claim 22, wherein the planting device includes a seed sensor configured to detect an orientation of a seed.

26. The irrigation vehicle of claim 22, wherein the application device applies liquid to a seed that has been planted by the planting device.

27. The irrigation vehicle of claim 22, wherein the seed is positioned within a cartridge and wherein a seed sensor determines an orientation of the seed with respect to the cartridge.

28. The irrigation vehicle of claim 22, wherein the planting device inserts seed into a furrow in the ground.

29. The irrigation vehicle of claim 28, wherein the planting device includes a firming device configured to firm the seed within the furrow.

30. The irrigation vehicle of claim 22, wherein the seed is positioned within a tape and the planting device selectively dispenses the tape from the vehicle.

31. A crop input application system, comprising:
a vehicle supporting a vehicle tank and a boom; and
a refilling apparatus configured for selective fluid coupling to the vehicle tank through the boom.

32. The crop input application system of claim 31, wherein the vehicle includes a battery.

33. The crop input application system of claim 32, wherein the refilling apparatus includes a power source configured to be electrically coupled to the battery.

34. The crop input application system of claim 31, wherein the refilling apparatus includes a connector for fluidly coupling to the boom.

35. The crop input application system of claim 34, wherein the connector is a funnel.

36. An irrigation vehicle, comprising:
a vehicle frame configured to traverse a field;
an application device configured to apply liquid to crops; and
a power generator supported by the vehicle frame and configured to generate power as liquid flows through the generator.

37. The irrigation vehicle of claim 36, further comprising a rotary sensor coupled to the conduit.

38. A combination of a field of crops and an irrigation vehicle having a reel and a fluid conduit disposed on the reel, the irrigation vehicle including a control system moving the vehicle along a plurality of predetermined paths in the field.

39. The combination of claim 38, wherein the control system follows the predetermined paths based on a guide element positioned in the field.

40. The combination of claim 38, wherein the control system follows the predetermined paths based on a global positioning system.

41. In combination, a source of manure and an irrigation vehicle having a reel and a fluid conduit disposed on the reel, the source of manure including a filter and a pump delivering manure to the fluid conduit.

42. An irrigation vehicle having a reel and a fluid conduit disposed on the reel, the irrigation vehicle further including a boom, the boom having a drop and an atomizing nozzle.

43. The irrigation vehicle of claim 42, wherein the drop includes at least two hoses positioned to deliver input to crops, the at least two hoses being of different length.

44. The irrigation vehicle of claim 42, wherein the drop includes a stabilizing element positioned to contact a row of crops.

45. The irrigation vehicle of claim 42, wherein the drop includes a flexible hose coupled to the boom.
